(19) United States
(12) Patent Application Publication
(10) Pub. No.: US 2016/0368056 A1
(43) Pub. Date: Dec. 22, 2016

(54) ADDITIVE MANUFACTURING WITH ELECTROSTATIC COMPACTION

(71) Applicants: Bharath Swaminathan, San Jose, CA (US); Ajey M. Joshi, San Jose, CA (US); Nag B. Patibandla, Pleasanton, CA (US); Hou T. Ng, Campbell, CA (US); Ashavani Kumar, Sunnyvale, CA (US); Eric Ng, Mountain View, CA (US); Bernard Frey, Livermore, CA (US); Kasiraman Krishnan, Milpitas, CA (US)

(72) Inventors: Bharath Swaminathan, San Jose, CA (US); Ajey M. Joshi, San Jose, CA (US); Nag B. Patibandla, Pleasanton, CA (US); Hou T. Ng, Campbell, CA (US); Ashavani Kumar, Sunnyvale, CA (US); Eric Ng, Mountain View, CA (US); Bernard Frey, Livermore, CA (US); Kasiraman Krishnan, Milpitas, CA (US)

(21) Appl. No.: 15/185,996

(22) Filed: Jun. 17, 2016

Related U.S. Application Data
(60) Provisional application No. 62/182,388, filed on Jun. 19, 2015.

(51) Int. Cl. B22F 3/16; B28B 1/00; B33Y 10/00; B33Y 30/00; B33Y 50/02; B23K 26/144; B22F 3/105; B22F 3/02; B23K 26/00; B23K 26/342; B23K 26/60; B29C 67/00; B22F 1/02

(52) U.S. Cl. CPC B22F 3/16; B29C 67/0081; B29C 67/0088; B29C 67/0085; B29C 67/0092; B28B 1/001; B33Y 10/00; B33Y 30/00; B33Y 50/02; B22F 1/02; B22F 3/1055; B22F 3/02; B23K 26/0006; B23K 26/342; B23K 26/60; B23K 26/144; B29K 2995/0006; B22F 2003/1056; B22F 2302/25; B22F 2303/01; B22F 2998/10; B23K 2203/172

(57) ABSTRACT

An additive manufacturing system includes a platen, a dispenser apparatus configured to deliver a layer of powder onto the platen or a previously dispensed layer on the platen, a voltage source coupled to the platen and configured to apply a voltage to the platen to create an electrostatic attraction of the powder to the platen sufficient to compact the powder, and an energy source configured to apply sufficient energy to the powder to fuse the powder.

### CROSS-REFERENCE TO RELATED APPLICATIONS

This application claims priority to U.S. Application Ser. No. 62/182,388, filed on Jun. 19, 2015, the entire disclosure of which is incorporated by reference.

### TECHNICAL FIELD

This invention relates to additive manufacturing, and more particularly to 3D printing process in which a layer of powder is dispensed.

### BACKGROUND

Additive manufacturing (AM), also known as solid freeform fabrication or 3D printing, refers to any manufacturing process where three-dimensional objects are built up from raw material (generally powders, liquids, suspensions, or molten solids) in a series of two-dimensional layers or cross-sections. In contrast, traditional machining techniques involve subtractive processes and produce objects that are cut out of a stock material such as a block of wood or metal.

A variety of additive processes can be used in additive manufacturing. The various processes differ in the way layers are deposited to create the finished objects and in the materials that are compatible for use in each process. Some methods melt or soften material to produce layers, e.g., selective laser melting (SLM) or direct metal laser sintering (DMLS), selective laser sintering (SLS), fused deposition modeling (FDM), while others cure liquid materials using different technologies, e.g. stereolithography (SLA).

Sintering is a process of fusing small grains, e.g., powders, to create objects. Sintering usually involves heating a powder. When a powdered material is heated to a sufficient temperature in a sintering process, the atoms in the powder particles diffuse across the boundaries of the particles, fusing the particles together to form a solid piece. In contrast to melting, the powder used in sintering need not reach a liquid phase. As the sintering temperature does not have to reach the melting point of the material, sintering is often used for materials with high melting points such as tungsten and molybdenum.

Both sintering and melting can be used in additive manufacturing. The material being used determines which process occurs. An amorphous solid, such as acrylonitrile butadiene styrene (ABS), is actually a supercooled viscous liquid, and does not actually melt; as melting involves a phase transition from a solid to a liquid state. Thus, selective laser sintering (SLS) is the relevant process for ABS, while selective laser melting (SLM) is used for crystalline and semi-crystalline materials such as nylon and metals, which have a discrete melting/freezing temperature and undergo melting during the SLM process.

Conventional systems that use a laser beam as the energy source for sintering or melting a powdered material typically direct the laser beam on a selected point in a layer of the powdered material and selectively raster scan the laser beam to locations across the layer. Once all the selected locations on the first layer are sintered or melted, a new layer of powdered material is deposited on top of the completed layer and the process is repeated layer by layer until the desired object is produced.

An electron beam can also be used as the energy source to cause sintering or melting in a material. Once again, the electron beam is raster scanned across the layer to complete the processing of a particular layer.

### SUMMARY

In one aspect, an additive manufacturing system includes a platen, a dispenser apparatus configured to deliver a layer of powder onto the platen or a previously dispensed layer on the platen, a voltage source coupled to the platen and configured to apply a voltage to the platen to create an electrostatic attraction of the powder to the platen sufficient to compact the powder, and an energy source configured to apply sufficient energy to the powder to fuse the powder.

Implementations include one or more of the following features. The voltage may be a DC voltage, e.g., between −4000 Volts and +4000 Volts.

The system can include a vacuum chamber, and the platen and dispenser are positioned in the vacuum chamber. The energy source may include a radio frequency (RF) power supply coupled to an electrode structure to apply sufficient energy within the vacuum chamber to generate a plasma within the vacuum chamber. The energy source may include a laser.

The electrode structure may include a conductive plate in the platen and a counter-electrode. The counter-electrode may include a second conductive plate positioned in the vacuum chamber, and the second conductive plate may be oriented substantially parallel to the platen. The voltage source may be configured to apply the voltage to the conductive plate. A controller may be coupled to the voltage source and the RF power supply, and the controller may be configured to cause the voltage to apply the voltage while the RF power supply applies sufficient energy to generate the plasma. The energy source may be a laser. The voltage source may be configured to apply the voltage between the platen and walls of the vacuum chamber.

The platen may include a conductive plate and a dielectric layer disposed over the conductive plate. The platen may be vertically movable.

In another aspect, a method of additive manufacturing includes dispensing a layer of powder onto the platen or a previously dispensed layer on the platen, compacting the powder on the platen by electrostatic attraction to provide a layer of compacted powder, and fusing the compacted powder.

Implementations include one or more of the following features. Compacting the powder may include applying a voltage to the platen. The voltage may be a DC voltage, e.g., a voltage between −4000 volts and +4000 volts.

Fusing the powder may include supporting the layer of compacted powder in a vacuum chamber and generating a plasma in the chamber above the layer of compacted powder. Generating the plasma may include applying RF between the platen and a cathode. The cathode may include walls of the vacuum chamber and/or a conductive plate in the vacuum chamber.

Fusing the powder may include applying a laser beam to the powder.

The platen may be vertically lowered between dispensing successive layers of powder.

The powder may include dielectric particles. The powder particles may have a metal core and a dielectric coating over the core. The dielectric coating may be a native oxide layer.

Implementations can include one or more of the following advantages. The quality of the additive manufacturing process can be improved, e.g., higher density of the fabricated object can be achieved. The electrostatic compaction force can be controlled, for example, by regulating the plasma in the process chamber.

The details of one or more embodiments of the invention are set forth in the accompanying drawings and the description below. Other aspects, features and advantages of the invention will be apparent from the description and drawings, and from the claims.

### DESCRIPTION OF DRAWINGS

FIG. 1 is a schematic side view of an additive manufacturing system.

FIG. 2A is a schematic side view of an electrostatic chuck with plasma.

FIG. 2B is a schematic side view of an electrostatic chuck without plasma.

FIG. 2C is a schematic side view of bipolar chuck.

FIG. 3 is a schematic side view of additive manufacturing system with two of feed materials.

Like reference symbols in the various drawings indicate like elements.

### DETAILED DESCRIPTION

An additive manufacturing process can involve dispensing a layer of feed material, for example, a powder, on a platen or a previously deposited layer, followed by a method to fuse portions of the layer of feed material. An energy source heats up the feed material and causes it to fuse together into a solid piece. It is sometimes desirable that, during the additive manufacturing process, the fresh layer of feed material is compacted prior to fusion. This can help improve the quality of additive manufacturing process, e.g., increase the density of the powder and thus the density of the manufactured object. One of the ways by which the fresh layer of feed material is compacted is by applying an electrostatic force on the feed material.

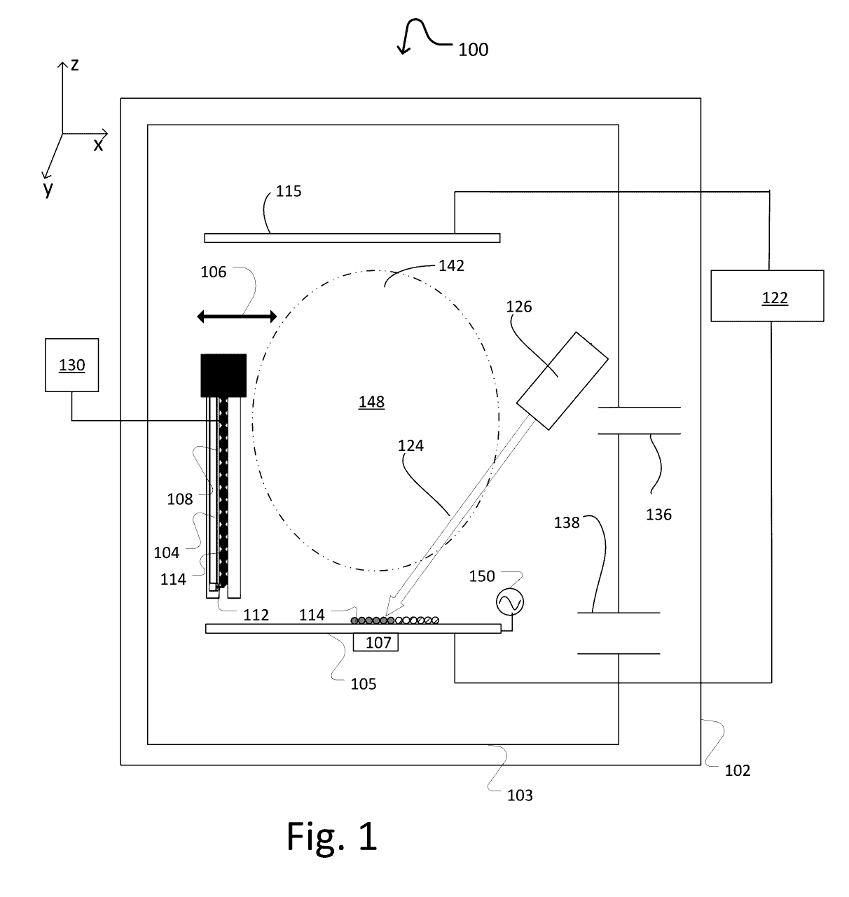

FIG. 1 shows a schematic of an exemplary additive manufacturing system 100. The system 100 includes and is enclosed by a housing 102. The housing 102 can, for example, allow a vacuum environment to be maintained in a chamber 103 inside the housing, e.g., pressures at about 1 Torr or below. Alternatively the interior of the chamber 103 can be a substantially pure gas, e.g., a gas that has been filtered to remove particulates, or the chamber can be vented to atmosphere. The gas can enter the chamber 103, from a gas source (not shown), through the gas inlet 136. The gas from the chamber can be removed through the vacuum vent 138. The vacuum environment or the filtered gas can reduce defects during manufacture of a part. In addition, a vacuum environment can aid in the generation of a plasma.

The additive manufacturing system 100 includes powder delivery system to deliver a layer of powder over a platen 105, e.g., on the platen or onto an underlying layer on the platen. The powder delivery system can include a material dispenser assembly 104 positionable above the platen 105. A vertical position of the platen 105 can be controlled by a piston 107.

In some implementations, the dispenser 104 includes a plurality of openings through which feed material can be dispensed. Each opening can have an independently controllable gate, so that delivery of the feed material through each opening can be independently controlled. In some implementations, the plurality of openings extend across the width of the platen, e.g., in direction perpendicular to the direction of travel 106 of the dispenser 104. In this case, in operation, the dispenser 104 can scan across the platen 105 in a single sweep in the direction 106. Alternatively, the dispenser 104 can move in two directions to scan across the platen 105, e.g., a raster scan across the platen 105. In some implementations, there can be multiple dispensers that dispense different materials over the platen.

A controller 130 controls a drive system (not shown), e.g., a linear actuator, connected to the dispenser assembly 104. The drive system is configured such that, during operation, the dispenser assembly is movable back and forth parallel to the top surface of the platen 105 (along the direction indicated by arrow 106). For example, the dispenser assembly 104 can be supported on a rail that extends across the chamber 103.

As the dispenser assembly 104 scans across the platen, the dispenser assembly 104 deposits feed material at an appropriate location on the platen 105 according to a printing pattern that can be stored as a computer aided design (CAD)-compatible file that is then read by a computer associated with the controller 130.

The dispenser assembly 104 includes a reservoir 108 to hold feed material 114. Release of the feed material 114 is controlled by a gate 112. Electronic control signals are sent to the gate 112 to dispense the feed material when the dispenser is translated to a position specified by the CAD-compatible file.

A power source can supply sufficient heat to the layer of feed material to cause the powder to fuse. Where the feed material is dispensed in a pattern, the power source can heat the entire layer simultaneously. For example, the power source could be a lamp array positioned above the platen 105 that radiatively heats the layer of feed material.

Alternatively, the feed material can be deposited uniformly on the platen 105 and the power source can be configured to heat locations specified by a printing pattern stored as a computer aided design (CAD)-compatible file to cause fusing of the powder at the locations.

For example, a laser beam 124 from a laser source 126 can be scanned across the platen 105, with laser power being controlled at each location to determine whether a particular voxel fuses or not. The laser beam 124 can also scan across locations specified by the CAD file to selectively fuse the feed material at those locations. To provide scanning of the laser beam 124 across the platen 105, the platen 105 can remain stationary while the laser beam 124 is horizontally displaced. Alternatively, the laser beam 124 can remain stationary while the platen 105 is horizontally displaced. An electron beam could be used instead of a laser beam.

As another example, a digitally addressable heat source in the form of an array of individually controllable light sources, e.g., a vertical-cavity surface-emitting laser (VCSEL) chips, can be positioned above the platen 105. The array of controllable light sources can be a linear array which is scanned across the platen 105, or a full two-dimensional array, which selectively heats regions of the layer according to which light sources are activated.

Where the feed material is deposited uniformly on the platen 105, the powder delivery system can include a roller that is moved horizontally (parallel to the surface of the platen) to push the feed material from a reservoir and across the platen 105.

During manufacturing, layers of feed materials are progressively deposited and sintered or melted. For example, the feed material 114 is dispensed from the dispenser assembly 104 to form a first layer 116 that contacts the platen 105. Subsequent layers of feed material are dispensed over previously deposited layers (whether fused or not).

The beam 124 from the power source 126 is configured to raise the temperature of a region of feed material that is irradiated by the beam. The platen 105 can additionally be heated by a heater, e.g., a heater embedded in the platen 105, to a base temperature that is below the melting point of the feed material. In this way, the beam 124 can be configured to provide a smaller temperature increase to melt the deposited feed material. Transitioning through a small temperature difference can enable the feed material to be processed more quickly. For example, the base temperature of the platen 105 can be about 1500° C. and the beam 124 can cause a temperature increase of about 50° C.

The power source 126 and/or the platen 105 can be coupled to an actuator assembly, e.g., a pair of linear actuators configured to provide motion in perpendicular directions, so as to provide relative motion between the beam 124 and the platen 105. The controller 130 can be connected to the actuator assembly to cause the beam 124 and plasma 148 to be scanned across the layer of feed material.

If generation of a plasma is desired, a gas is supplied to the chamber 103 through a gas inlet 136. Applying radio frequency (RF) power on the platen 105 from the RF power source 150 can lead to the generation of plasma 148 in the discharge space 142. The plasma 148 is depicted as an ellipse only for illustrative purposes. In general, the plasma fills the region between the platen 105 and a counter electrode 115. The amplitude of the RF, generated from the RF power source 150, can be used to control the flux of ions in the plasma. The frequency of the RF, generated from the RF power source 150, can be used to control the energy of ions in the plasma.

The platen 105 and the counter electrode 115 are also connected to a voltage source 122 to generate a voltage difference between the platen 105 and the counter electrode 115. The voltage source 122 can, for example, be a DC voltage source.

Operating the system 100 under a vacuum environment may provide quality control for the material formed from processes occurring in the system 100. Nonetheless, for some systems the plasma 148 can also be produced under atmospheric pressure.

A plasma is an electrically neutral medium of positive and negative particles (i.e. the overall charge of a plasma is roughly zero). For example, when nitrogen gas is supplied from the gas source, it becomes ionized to produce N2+ or N+. These positive ions and electrons produced from the ionization form the plasma 148.

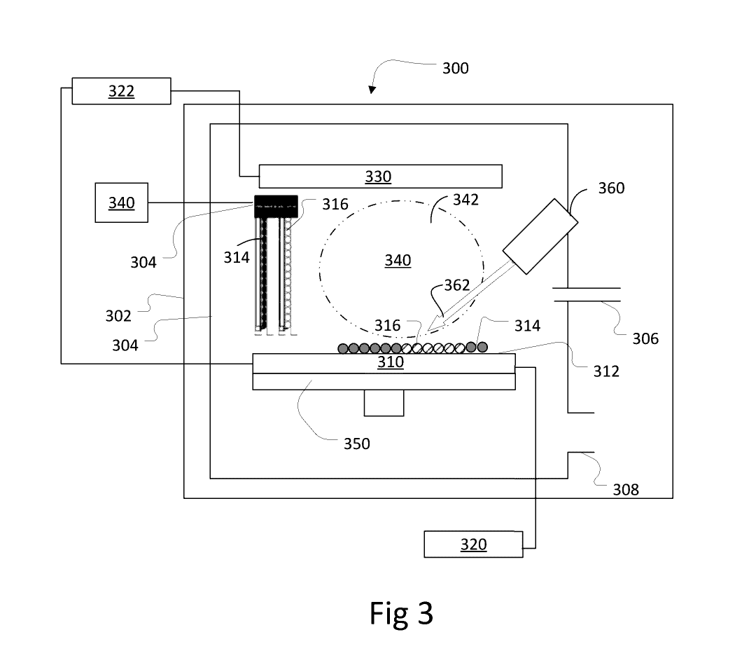

More than one feed material can be provided by the dispenser assembly 104. This will be further discussed with reference to FIG. 3. In such a case, each feed material can be stored in a separate reservoir having its own control gate and be individually controlled to release respective feed material at locations on the platen 105 as specified by the CAD file. In this way, two or more different chemical substance can be used to produce an additively manufactured part.

The feed material can be dry powders, metallic, ceramic, or plastic particles, metallic, ceramic, or plastic powders in liquid suspension, or a slurry suspension of a material. For example, for a dispenser that uses a piezoelectric printhead, the feed material would typically be particles in a liquid suspension. In the case of a suspension, the liquid component can be evaporated prior to the compaction discussed below.

In some embodiments, the controller 130 can be used to adjust a gas flow rate entering gas inlet 136 from the gas source (not shown). In some embodiments, the controller 130 can be used to adjust the voltage applied to the platen 105 and counter electrode 115. The adjustments can be made in conjunction with a position (x-y position) of the laser beam on a particular layer (Z position) of feed material. In this way, the desired chemical composition of the fabricated part can vary as a function of lateral (x-y) position within a particular feed layer. As an example, if the feed material is titanium, particular locations on the layer of feed material can react with the oxygen to form titanium oxide. The flow of oxygen can be stopped, and a flow of nitrogen can be initiated to produce titanium nitride at another location in the layer of feed material. In addition to chemically modifying the surface or changing a surface roughness of the additively manufactured part, the point plasma source can also be used for subtractive manufacturing by removing portions of a manufactured part. In this way, the subtractive process can be used to improve resolution in the manufactured part. In this way, the methods and apparatus allow full three dimensional (x, y, z) control of the chemical composition and surface roughness of all points within the additively manufactured part.

In operation, after each layer has been deposited and heat treated, the platen 105 is lowered by an amount substantially equal to the thickness of layer. Then the dispenser 104, which does not need to be translated in the vertical direction, scans horizontally across the platen to deposit a new layer that overlays the previously deposited layer, and the new layer can then be heat treated to fuse the feed material. This process can be repeated until the full 3-dimensional object is fabricated. The fused feed material derived by heat treatment of the feed material provides the additively manufactured object.

The use of plasma allows characteristics of the fused feed material to be easily controlled. For example, the layer of feed material can be doped by selectively implanting ions from the plasma. The doping concentration can be varied layer by layer. The implantation of ions can help release or induce point stress in the layer of feed material. Examples of dopants include phosphorous.

As described earlier, with reference to FIG. 1, interaction between the beam 124 and the feed material 114 can melt or soften the feed material, or cause interdiffusion of the material at the surface of the powder. As a result, the feed material can fuse together to form a solid piece.

For some processes, compaction of the feed material before sintering can improve the quality of the part generated by the additive manufacturing process. For example, compaction can provide a higher density part. The compaction of the feed material can be achieved, for example, by applying mechanical and/or electrostatic pressure on the feed material.

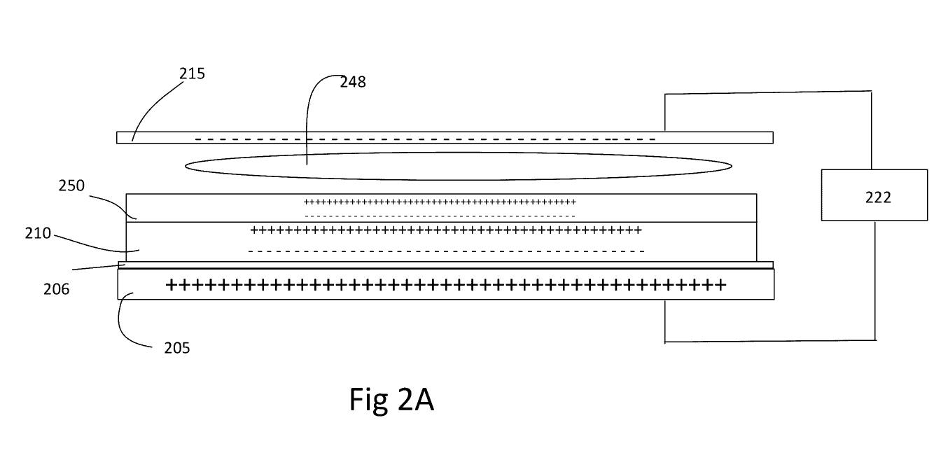

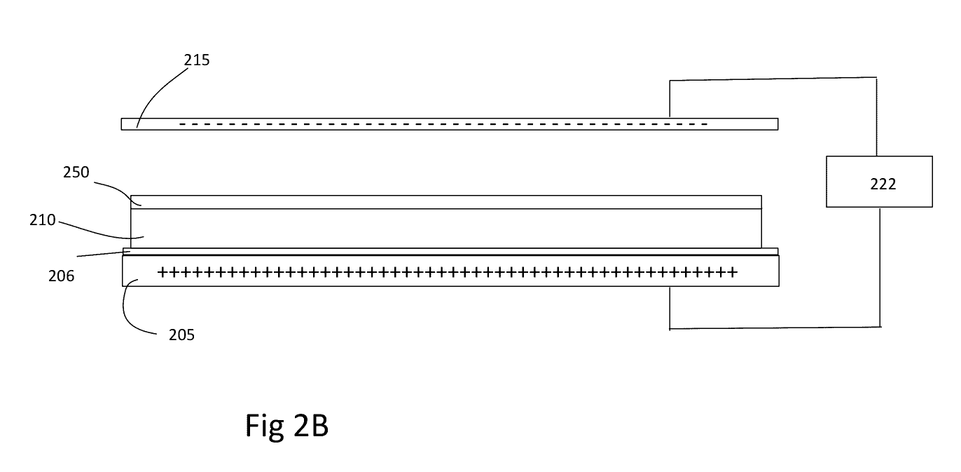

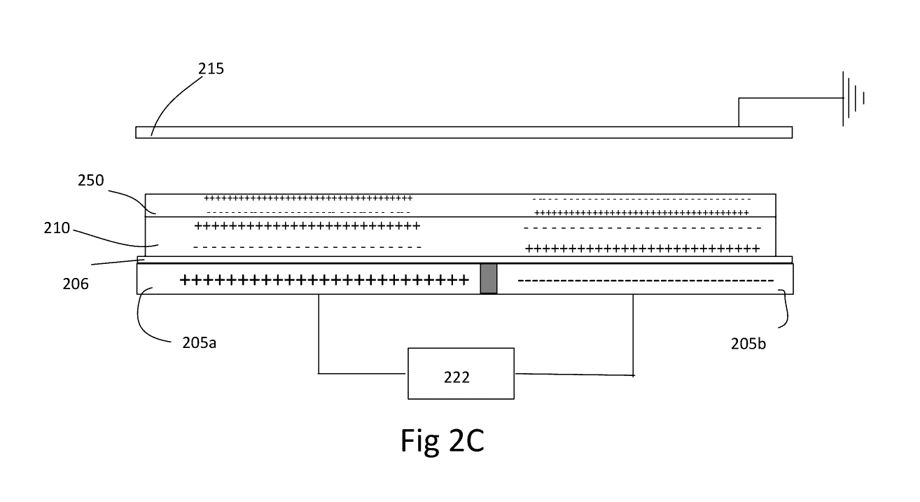

FIG. 2A shows an embodiment of an electrostatic chuck in which compaction of the feed material can be achieved by applying an electrostatic force. The chuck, which can be the platen 105, includes a conductive plate 205. Optionally, the chuck can include a dielectric layer 206 that coats the plate 205 on the side onto which the feed material is dispensed. The plate 205 and an electrode 215 are connected to a voltage source 222. The electrode 215 can be the counter electrode 115 that would be used for plasma generation. The voltage source 222 can be, for example, a voltage source that can apply a DC potential difference between the plate 205 and the electrode 215. The feed material is deposited and fused on top of the dielectric layer 206. As the additive manufacturing process progresses, fresh layer of feed material 250 is deposited on the fused material 210.

The feed material can be, for example, dielectric particles, metallic particles, or particles with a metal core surrounded by a layer of dielectric material. The particles can be about 1 μm to 150 μm. The layer of dielectric material can be between 10 nm to 2 μm thick.

Examples of the metal for metallic particles or the metal core include titanium, stainless steel, nickel, cobalt, chromium, vanadium and various alloys of these metals. Examples of dielectric materials for the particles or the dielectric layer include ceramics and plastics. Examples of ceramic materials include metal oxide, such as ceria, alumina, silica, aluminum nitride, silicon nitride, silicon carbide, or a combination of these materials. Examples of plastics include ABS, nylon, Ultem, polyurethane, acrylate, epoxy, polyetherimide, or polyamides.

The voltage source 222 applies a sufficient voltage to the plate 205 to cause the powder on platen to be electrostatically compacted. The voltage sufficient for compaction can be at least 200 V, e.g., 300-500 V, but voltage up to 4000 V are possible with appropriate hardware and good grounding.

In the implementation shown in FIG. 2A, the space between the feed material 250 and the electrode 215 contains plasma 248. The plasma 248 can be generated by applying an RF voltage between platen 205 and electrode 215 (as shown in FIG. 1). Due to the presence of plasma 248, when the power source 222 applies a voltage across the platen 205 and the electrode 215, most of the potential drop occurs across any previously deposited layers and the layer of fresh feed material 250.

The plate 205 can be at a higher potential than the electrode 215 (as shown in FIG. 2A). Without being limited to any particular theory, if the feed material is a powder of dielectric particles, the voltage difference across the feed material caused by the applied voltage causes the feed material layers 210 and 250 to be polarized such that the negative polarization is closer to the platen 205 (see FIG. 2A). As a result, the layer of fresh feed material 250 is attracted towards the platen 205. This attraction leads to the compaction of the fresh layer 250. During generation of a plasma, the platen can be maintained at a lower or higher DC potential to decelerate or accelerate ions, in addition to RF bias.

In addition, the powder can either be charged either before or while being dispensed, or be charged by the plasma after being dispensed onto the platen. Again, without being limited to any particular theory, if the feed material is a powder of charged metallic or dielectric particles, the powder can be compacted by choosing the polarity of the platen 205 that is opposite to that of the charge of the particles. If the particles are metallic, then the dielectric coating 206 acts as an insulating layer and prevents the discharge of the metallic feed particle through the plate 205.

In some implementations, a voltage pulse of opposite polarity can be applied to the platen. For example, applying such a voltage pulse can assist in dechucking the part so that the part can be removed without any damage to the anchored layers. In addition, the risk of electrical discharge from the platen can be reduced by conductive grounding straps.

The electrostatic chuck shown in FIG. 2B is similar that in FIG. 2A. However, there is no plasma between the layer of feed material 250 and the electrode 215. While use a plasma can provide superior compaction, for some processes sufficient compaction can still be provided without the plasma, or by increasing the applied voltage. Without being limited to any particular theory, when the power source 222 applies voltage across the platen 205 and the electrode 215, the potential drop across the gap between the electrode 215 and the layer of fresh feed material 250 is much greater than the potential drop across the layer of sintered feed material 210 and the layer of fresh feed material 250. As a result, it is expected that the electrostatic compaction will be stronger for the implementation described with reference to FIG. 2A.

FIG. 2C shows a bipolar electrostatic chuck. The platen comprises of two subparts: the subpart at a higher potential 205a and a subpart at a lower potential 205b. The electrode 215 is connected to the ground. The bipolar electrostatic chuck achieves compaction of the fresh layer of feed by a similar mechanism as described for the electrostatic chuck in FIG. 2A. A plasma is not necessary for chucking with a bipolar electrostatic chuck.

FIG. 3 shows an additive manufacturing system 300. The additive manufacturing system 300 is similar to the additive manufacturing system 100, but the dispenser assembly 304 can deposit two feed materials 314 and 316. The electrostatic chuck comprises of the plate 310 and the electrode 330. The platen 310 is connected to the RF power source 320. The platen 310 and the electrode 330 are connected to an external power supply 322 that applies a potential difference between the platen 310 and the electrode 330. Plasma 340 is generated from the gas that enters the chamber 304 from the gas inlet 306.

Although the implementations illustrated above show a separate counter-electrode suspended in the chamber, portions of the chamber walls could provide the counter- electrode. In addition, the counter-electrode could simply be grounded.

In some implementations, the electrostatic compaction can be completed before the feed material is fused. In some implementations, the electrostatic compaction is performed before and/or during application of the energy to fuse the feed material.

The implementations described above use electrostatic compaction, but the electrostatic compaction could be performed in conjunction with mechanical compaction. For example, a roller could be translated across the layer of feed material and used to apply pressure to the feed material before, during or after the electrostatic compaction.

Embodiments of the invention and all of the functional operations described in this specification can be implemented in digital electronic circuitry, or in computer software, firmware, or hardware, including the structural means disclosed in this specification and structural equivalents thereof, or in combinations of them. Embodiments of the invention can be implemented as one or more computer program products, i.e., one or more computer programs tangibly embodied in an information carrier, e.g., in a non-transitory machine readable storage medium or in a propagated signal, for execution by, or to control the operation of, data processing apparatus, e.g., a programmable processor, a computer, or multiple processors or computers. A computer program (also known as a program, software, software application, or code) can be written in any form of programming language, including compiled or interpreted languages, and it can be deployed in any form, including as a standalone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network. The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

A number of implementations have been described. Nevertheless, it will be understood that various modifications may be made. Accordingly, other implementations are within the scope of the following claims.

What is claimed is:

1. An additive manufacturing system comprising:
a platen;
a dispenser apparatus configured to deliver a layer of powder onto the platen or a previously dispensed layer on the platen;
a voltage source coupled to the platen and configured to apply a voltage to the platen to create an electrostatic attraction of the powder to the platen sufficient to compact the powder; and
an energy source configured to apply sufficient energy to the powder to fuse the powder.

2. The system of claim 1, wherein the voltage comprises a DC voltage.

3. The system of claim 2, wherein the DC voltage is between −4000 Volts and +4000 Volts.

4. The system of claim 1, comprising a vacuum chamber, wherein the platen and dispenser are positioned in the vacuum chamber.

5. The system of claim 4, wherein the energy source comprises a radio frequency (RF) power supply coupled to an electrode structure to apply sufficient energy within the vacuum chamber to generate a plasma within the vacuum chamber.

6. The system of claim 5, wherein the electrode structure comprises a conductive plate in the platen and a counter-electrode.

7. The system of claim 6, wherein the voltage source is configured to apply the voltage to the conductive plate.

8. The system of claim 5, comprising a controller coupled to the voltage source and the RF power supply, the controller configured to cause the voltage to apply the voltage while the RF power supply applies sufficient energy to generate the plasma.

9. The system of claim 4, wherein the voltage source is configured to apply the voltage between the platen and walls of the vacuum chamber.

10. The system of claim 1, wherein the energy source comprises a laser.

11. The system of claim 1, wherein the platen comprises a conductive plate and a dielectric layer disposed over the conductive plate.

12. A method of additive manufacturing, comprising:
dispensing a layer of powder onto the platen or a previously dispensed layer on the platen;
compacting the powder on the platen by electrostatic attraction to provide a layer of compacted powder; and
fusing the compacted powder.

13. The method of claim 12, wherein compacting the powder comprises applying a voltage to the platen.

14. The method of claim 13, wherein applying a voltage comprises applying a DC voltage.

15. The method of claim 14, wherein applying the DC voltage comprises applying a voltage between −4000 volts and +4000 volts.

16. The method of claim 12, wherein fusing the powder comprises supporting the layer of compacted powder in a vacuum chamber and generating a plasma in the chamber above the layer of compacted powder.

17. The method of claim 12, wherein fusing the powder comprises applying a laser beam to the powder.

18. The method of claim 12, wherein the powder comprises dielectric particles.

19. The method of claim 12, wherein the powder comprises particles having a metal core and a dielectric coating over the core.

20. The method of claim 19, wherein the dielectric coating comprises a native oxide layer.
